(19) United States
(12) Patent Application Publication
(10) Pub. No.: US 2020/0133207 A1
(43) Pub. Date: Apr. 30, 2020

(54) CONTROL METHOD BASED ON DISTURBANCE PERCEPTION

(71) Applicant: Zhezhao ZENG, Changsha (CN)

(72) Inventor: Zhezhao ZENG, Changsha (CN)

(21) Appl. No.: 16/729,341

(22) Filed: Dec. 28, 2019

Related U.S. Application Data
(63) Continuation of application No. PCT/CN2018/115314, filed on Nov. 14, 2018.

(30) Foreign Application Priority Data
Mar. 2, 2018 (CN) 201810175424.X

(51) Int. Cl. G05B 11/42

(52) U.S. Cl. CPC G05B 11/42

(57) ABSTRACT

Disclosed herein is a control method based on disturbance perception, which relates to control theory and engineering. In the method, an error-based dynamic system is established under motivation of the total disturbance based on the error between the expected value and the actual output value of the system, based on which a Disturbance Perception Controller (DPC) model is further established. The control method generally includes the establishment of a tracking error and an integral thereof, and a differential based on a desired trajectory and differential signals thereof, and an actual output of a nonlinear uncertain object and determination of a disturbance perception control law.

### CROSS-REFERENCE TO RELATED APPLICATIONS

This application is a continuation of International Patent Application No. PCT/CN2018/115314, filed on Nov. 14, 2018, which claims the benefit of priority from Chinese Patent Application No. 201810175424.X, filed on Mar. 2, 2018. The contents of the aforementioned applications, including any intervening amendments thereto, are incorporated herein by reference.

### TECHNICAL FIELD

The present invention relates to control theory and engineering, particularly to the control for a nonlinear uncertain system, and more particularly to a control method based on disturbance perception.

### BACKGROUND OF THE PRESENT INVENTION

In the past nearly half a century, classical control (control theory) based on frequency domain design and modern control (model theory) based on time domain design have been developed independently to form their own methodological systems. In the practical control engineering, an error between the control target and the actual behavior of the controlled object is easy to obtain and can be appropriately processed. Therefore, the Proportional-Integral-Derivative (PID) controller, originated from the control strategy of “eliminating errors based on errors”, has been widely used in the industrial control. Since it is often difficult to describe the problems existing in the practical control engineering from a view of internal mechanism the control strategies derived from the modern control theory based on mathematical models are difficult to be effectively applied in actual control engineering. This is the disconnection between control engineering practice and control theory, which has lasted for more than half a century without being well resolved. The essence of the classical control theory is to propose a control strategy based on the deviation between the actual value and the control target, where the control target can be achieved as long as the PID gain is reasonably selected to stabilize a closed-loop system, which accounts for the wide application of PID. However, the development of science and technology has put forward higher requirements for the accuracy, speed and robustness of the controller and the existing PID control is no longer suitable due to some disadvantages. For example, although the PID control can ensure system stability, the dynamic quality of the closed-loop system is sensitive to changes in PID gain, which leads to the irreconcilable contradiction between “fast response” and “overshoot” in the control system. Therefore, the controller gain also needs to be adjusted accordingly with the change of the system operating conditions, which promotes the development of various improved PID control methods such as self-adaptive PID, nonlinear PID, neuron PID, intelligent PID, fuzzy PID and expert system PID. Although the existing PIDs can improve the system in the self-adaptive control capability by stabilizing the controller gain parameters online, they still fail to be applied to the control of nonlinear uncertain systems, especially due to the poor anti-disturbance capability. In addition, the PID control principle is to subject the past (I), present (P), and future (change trend D) to weighted sum to form a control signal. Although effective control can be applied as long as the three gain parameters of PID are reasonably selected, there is no way to process the error, the integral and differentiation thereof by weighted sum since these three physical quantities are completely different in properties. Exactly due to the inherent irrationality, the PID has been extensively investigated with respect to the stabilization of PID parameters by domestic and foreign researchers engaging in control theory and control engineering. Therefore, there is an urgent need to develop a new robust control method with simple model structure, easy parameter stabilization, good dynamic quality and strong anti-disturbance capability.

### SUMMARY OF THE PRESENT INVENTION

The present application provides a control method based on disturbance perception, comprising:

(1) establishing a tracking error e₁ and an integral e₀ thereof, and a differential e₂ based on a desired trajectory y_{d} and differential signals thereof [symbol] and [symbol] and an actual output of a nonlinear uncertain object y equal to y=y₁:

$${e}_{1} = {y}_{d} - y , {e}_{2} = \text{?} - {y}_{2} , {e}_{0} = {\int }_{0}^{t} {e}_{1} d τ ;$$

$$\text{?} \text{indicates text missing or illegible when filed}$$

wherein, y₂= [symbol] = [symbol] ;

(2) defining a disturbance perception control law based on e₁, e₂, e₀ and [symbol] obtained from step (1): u=b0⁻⁽ [symbol] ^{+z}_{c}³e₀+3z_{c}²e₁+3z_{c}e₂);

wherein, z_{c}=h^{-α(}1.1−e^{-βt}); 0<α<1; 0<β≤0.5; h is integration step, b₀ is an estimate of a nonlinear uncertain function g(y₁, y₂, t), and is a non-zero constant; and

(3) limiting the integral e₀ of the tracking error to |e₀|≤z_{c}⁻³.

The total disturbance is defined herein to include controlled system dynamics, internal uncertainties and external disturbances, and then an error-based dynamic system is established under motivation of the total disturbance based on the error between the expected value and the actual output value of the system, based on which a Disturbance Perception Controller (DPC) model is further established to demonstrate that the DPC not only has a global asymptotic stability, but also has a strong anti-disturbance performance. The invention provides a control method based on disturbance perception herein, in which the concepts of system properties such as linearity and non-linearity, certainty and uncertainty, time variance and time invariance, affine and non-affine are completely diluted, and the gain parameters of the DPC can be stabilized completely according to the integration step, effectively solving the difficulty in stabilizing PID parameters and realizing the intelligent control in the true sense. In addition, compared to the prior art, the invention also has the outstanding advantages of:

(1) global asymptotic stability;

(2) parameter-free stabilization;

(3) simple structure, small calculation amount and good real-time performance;

(4) fast response and good dynamic qualities such as free of overshoot and buffeting; and

(5) strong anti-disturbance ability.

### BRIEF DESCRIPTION OF THE DRAWINGS

FIG. 1 schematically shows a disturbance perception control (DPC) system model.

FIGS. 2A-C show a dynamic performance test result of a nonlinear uncertain system 1, where FIG. 2A shows a tracking control curve; FIG. 2B shows a control signal change curve; and FIG. 2C shows a tracking control error change curve.

FIGS. 3A-C show a dynamic performance test result of a nonlinear uncertain system 2, where FIG. 3A shows a tracking control curve, FIG. 3B shows a control signal change curve, and FIG. 3C shows a tracking control error change curve.

FIGS. 4A-D show the anti-disturbance capability of the nonlinear uncertain system 1, where FIG. 4A shows a tracking control curve, FIG. 4B shows a control signal change curve, FIG. 4C shows a tracking control error change curve, and FIG. 4D shows an external disturbance signal.

FIGS. 5A-D show the anti-disturbance capability of the nonlinear uncertain system 2, where FIG. 5A shows a tracking control curve, FIG. 5B shows a control signal change curve, FIG. 5C shows a tracking control error change curve, and FIG. 5D shows an external sinusoidal disturbance signal.

FIGS. 6A-D show the anti-disturbance capability of the nonlinear uncertain system 2, where FIG. 6A shows a tracking control curve, FIG. 6B shows a control signal change curve, FIG. 6C shows a tracking control error change curve, and FIG. 6D shows an external oscillation disturbance signal.

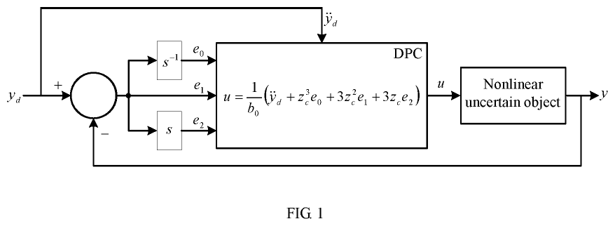

### DETAILED DESCRIPTION OF EMBODIMENTS

### 1. Mapping Idea from Nonlinear Uncertain System Model to Disturbance Perception Model

A second-order nonlinear uncertain system model is established as follows:

$$\{ \begin{matrix}\text{?} = {y}_{2} \\ \text{?} = f ( {y}_{1} , {y}_{2} , t ) + d + g ( {y}_{1} , {y}_{2} , t ) u \\ y = {y}_{1}\end{matrix} ; \\ \text{?} \text{indicates text missing or illegible when filed} \qquad ( 1 )$$

where y₁, y₂ are two measurable states of the system, and y₁, y₂∈R; u is a control input of the system, and u∈R; ƒ(y₁, y₂, t) and g(y₁, y₂, t) are unknown smoothing functions of the system, and g(y₁,y₂,t) is non-negative; d is an external disturbance; and Y is a system output.

An unknown total disturbance state (also called an extended state) y₃ is defined as:

y₃=ƒ(y₁,y₂,t)+d+g(y₁,y₂,t)u−b₀u (2);

then, equation (1) can be rewritten as follows:

$$\{ \begin{matrix}\text{?} = {y}_{2} \\ \text{?} = {y}_{3} + {b}_{0} u \\ y = {y}_{1}\end{matrix} ; \\ \text{?} \text{indicates text missing or illegible when filed} \qquad ( 3 )$$

where b₀ is an estimate of a nonlinear uncertain function and is a non-zero constant.

Since there are no restrictions on the total disturbance state y₃, and many nonlinear uncertain systems can be expressed in the form of the disturbance system (3), the disturbance system (3) has universal significance. Moreover, in the disturbance system defined herein, the boundaries and concepts of system properties such as linearity and non-linearity, certainty and uncertainty, time-variance and time-invariance, affinity and non-affinity are completely diluted, which effectively solves the difficulty in the past decades that how to select a method for effectively controlling a system with a specific attribute according to the two control ideologies of control theory and model theory.

How to effectively control the disturbance system (3) is the core technical problem of the invention, and in view of this problem, the invention discloses a control technique based on disturbance perception.

### 2. Design of Disturbance Perception Controller (DPC)

Considering the problem in the control of an unknown disturbance system (3), the expected trajectory is let to be y_{d}, and the tracking control error is defined as follows:

e₁=y_{d}−y₁ (4).

Accordingly, the differential e₂ of the error and the integral e₀ of the error are:

$$\begin{matrix} {e}_{2} = \text{?} - {y}_{2} & ( 5 ) \\ {e}_{0} = {\int }_{0}^{t} {e}_{1} d τ . \\ \text{?} \text{indicates text missing or illegible when filed} & ( 6 )\end{matrix}$$

Equation (5) is differentiated, and the differentiated Equation (5) was combined with the disturbance system (3) to obtain Equation (7):

$$\text{?} - {y}_{3} - {b}_{0} u . \\ \text{?} \text{indicates text missing or illegible when filed} \qquad ( 7 )$$

Based on Equations (5), (6) and (7), a disturbance error system can be established as follows:

$$\{ \begin{matrix}\text{?} = {e}_{1} \\ \text{?} = {e}_{2} \\ \text{?} - {y}_{3} - {b}_{0} u\end{matrix} . \\ \text{?} \text{indicates text missing or illegible when filed} \qquad ( 8 )$$

Obviously, the system (8) is a third-order Disturbance Perception Error Dynamical System (DPEDS), and in order to stabilize the DPEDS, the disturbance perception control law u is defined as follows:

$$u = {b}_{0}^{- 1} ( \text{?} + {z}_{c}^{3} {e}_{0} + 3 {z}_{c}^{2} {e}_{1} + 3 {z}_{c} {e}_{2} ) ; \\ \text{?} \text{indicates text missing or illegible when filed} \qquad ( 9 )$$

where the gain parameter z_{c}>0.

### 3. Stability Analysis of Disturbance Perception Control System (DPCS)

By applying the disturbance perception controller (9) to the nonlinear uncertain system (1) or (3), a closed-loop Disturbance Perception Control System (DPCS) can be obtained. In order to ensure the stability of DPCS, the Disturbance Perception Controller (DPC) is required to be stable.

Principle 1: If and only if the controller gain parameter z_{c}>0, the Disturbance Perception Controller (DPC) expressed by Equation (9) is globally asymptotically stable and has strong anti-disturbance capability.

The principle 1 is demonstrated as follows.

The disturbance perception control law (9) is substituting into the Disturbance Perception Error Dynamic System (DPEDS) expressed by Equation (8) to obtain a disturbance perception error system (10):

$$\{ \begin{matrix}\text{?} = {e}_{1} \\ \text{?} = {e}_{2} \\ \text{?} - {y}_{3} - {z}_{c}^{3} {e}_{0} - 3 {z}_{c}^{2} {e}_{1} - 3 {z}_{c} {e}_{2}\end{matrix} . \\ \text{?} \text{indicates text missing or illegible when filed} \qquad ( 10 )$$

The disturbance perception error system (10) is subjected to Laplace transform to obtain Equation (11):

$$\{ \begin{matrix}s {E}_{0} ( s ) = {E}_{1} ( s ) \\ s {E}_{1} ( s ) = {E}_{2} ( s ) \\ s {E}_{2} ( s ) = - {Y}_{3} ( s ) - {z}_{c}^{3} {E}_{0} ( s ) - 3 {z}_{c}^{2} {E}_{1} ( s ) - 3 {z}_{c} {E}_{2} ( s )\end{matrix} . \qquad ( 11 )$$

Then Equation (11) is adjusted to obtain Equation (12):

(s³+3z_{c}s²+3z_{c}²s+z_{c}³)E₁(s)=−sY₃(s) (12),

i.e.,

(s+z_{c})³E₁(s)=−sY₃(s) (13).

Obviously, the error system (13) is a third-order error system under the excitation of the total unknown disturbance y₃, which has a system transfer function shown as follows:

$$H ( s ) = \frac{{E}_{1} ( s )}{{Y}_{3} ( s )} = - \frac{s}{{( s + {z}_{c} )}^{3}} . \qquad ( 14 )$$

According to signal and the theory of system complex frequency domain analysis, if and only if the gain parameter z_{c}>0, the disturbance perception error system (14) is asymptotically stable,

$$i . e . , {lim}_{t -> ∞} {e}_{1} ( t ) = 0 ,$$

such that the Disturbance Perception Controller (DPC) expressed by Equation (9) is globally asymptotically stable. Since the global stability of the DPC has nothing to do with the nature of the total unknown disturbance state y³, it is theoretically proved that the disturbance perception controller (9) has a strong anti-disturbance capability.

### 4. Stabilization Method for Gain Parameter of Disturbance Perception Controller

The Disturbance Perception Controller (DPC) has only one gain parameter z_{c} which needs to be stabilized. Since Principle 1 has proved that the Disturbance Perception Controller (DPC) is globally stable if and only if the gain parameter z_{c}>0, it is theoretically demonstrated that the gain parameter z_{c} of the DPC has a large margin. However, in addition to ensuring the global stability of the DPC, it is also required that the DPC has fast response and strong anti-disturbance capability, so it is also required to reasonably stabilize the gain parameter z_{c} of the DPC, where the method is specifically described as follows.

It can be seen from the verification process of Principle 1 that a corresponding unit impulse response can be obtained according to the transfer function of the disturbance perception error system (14):

h(t)=t(0.5z_{c}t−1)e^{-z}^{_{c}}^{t}ϵ(t) (15).

Obviously, the larger the gain parameter of the DPC, the faster the speed of h(t)→0. However, the differential peak phenomenon of error and the integral saturation phenomenon of error may occur in the transient beginning when z_{c} is too large. Therefore, it is required to reasonably stabilize the gain parameter of the DPC. The gain parameter is usually defined as: z_{c}=h^{-α}, where 0<α<1. In order to effectively avoid the overshoot of the control system during the transient state, self-adaptive gain is usually used, that is:

z_{c}=h^{-α}(1.1−e^{-βt}) (16),

where h is integration step, 0<α<1, 0<β≤0.5, an |e₀|≤z_{c}⁻³.

### 5. Performance Test and Analysis

In order to verify the effectiveness of the invention, the following simulation experiments are performed for the control of nonlinear uncertain objects of two different models. The relevant simulation conditions of the disturbance perception controller are set as follows.

On the premise of integration step h=0.01, α and β are respectively set to be 0.55 and 0.95 to obtain the self-adaptive gain parameter of the DPC: z_{c}=12[1−0.95exp(−t)]. In all of the following simulation experiments, the gain parameter of the DPC is exactly the same.

Two nonlinear uncertain control object models are respectively established as follows:

$$\{ \begin{matrix}\text{?} = {y}_{2} \\ \text{?} = f ( t , {y}_{1} , {y}_{2} ) + d + g ( t , {y}_{1} {y}_{2} ) u \\ y = {y}_{1}\end{matrix} , \\ \text{?} \text{indicates text missing or illegible when filed} \qquad ( 17 )$$

where ƒ(t, y₁, y₂)=e^{y}^{₂} cos(y₁), g(t, y₁, y₂)=1+sin²(t), d is an external disturbance, and the initial state is set to be: y₁(0)=1, y₂(0)=0; and let b₀=1;

and

$$\{ \begin{matrix}\text{?} = {y}_{2} \\ \text{?} = - \frac{MgL}{2 J} sin ( {y}_{1} ) - \frac{{V}_{s}}{J} {y}_{2} + d + \frac{1}{J} u \\ y = {y}_{1}\end{matrix} \\ \text{?} \text{indicates text missing or illegible when filed} \qquad ( 18 )$$

where y₁ is pendulum angle, y₂ is pendulum speed; g is the gravitational acceleration; M is the mass of the pendulum rod; L is the length of the pendulum; J=MP is the moment of inertia; Vₛ is the coefficient of viscous friction; d is an external disturbance. The relevant parameters of the controlled system are set to be: g=9.8 m/s², Vₛ=0.18, M=1.1 kg and L=1 m; d is the external disturbance; initial state: y₁(0)=−π/3, y₂(0)=2; and let b₀=1/J.

### (1) Dynamic Performance Test

Dynamic performance tests are performed respectively on the controlled objects of the two different models expressed by Equations (17) and (18) to verify the control performance of the DPC in response speed, accuracy and stability.

### Control Performance Test for Object 1

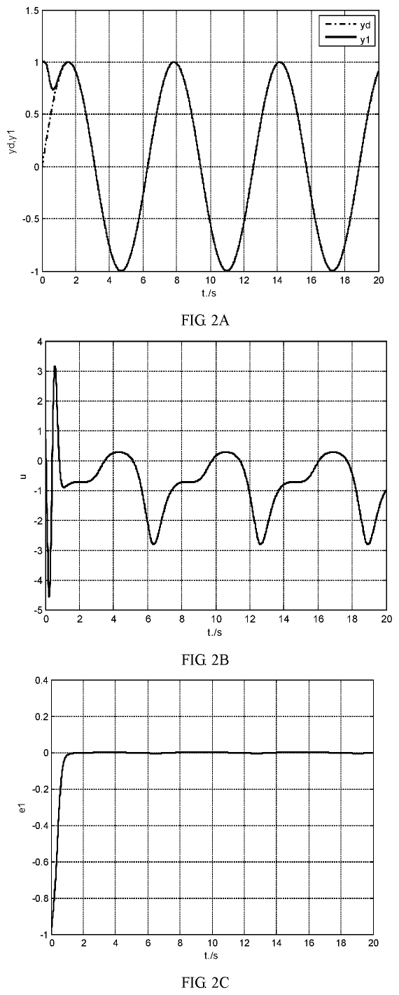

Given the desired trajectory as y_{d}=sin(t) , the test results are as shown in FIGS. 2A-2C in the absence of external disturbance using the control method of the invention. It can be obtained that the disturbance perception controller enables the controlled object to fully track the desired trajectory after about 0.7 s, which indicates that the disturbance perception controller not only has a fast response and high control accuracy, but also has strong robust stability, demonstrating the effectiveness of the invention.

### Control Performance Test for Object 2

A control object for the inverted pendulum is to make it approach the unstable equilibrium point, i.e., (0, 0), as soon as possible from any non-zero initial state (y₁⁰, y₂⁰).

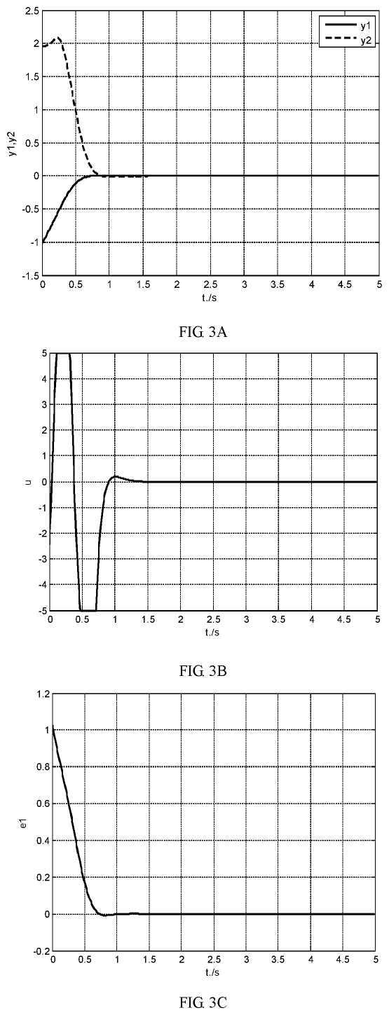

In the case of the absence of external disturbance and the use of the control method provided herein, the simulation results are obtained as shown in FIGS. 3A-3C. It can be seen that the inverted pendulum can approach the unstable equilibrium point, i.e., (0,0), from the initial state (−π/3,2) after about 0.7 s, which indicates that the disturbance perception controller not only has a fast response and high control accuracy, but also has strong robust control performance, demonstrating the effectiveness of the invention.

The above dynamic control performance test results show that in the case of no external disturbance, desirable results are obtained when DPCs with the same gain parameter are used to control two completely different objects (17) and (18). Therefore, compared to the prior art, the invention not only has a fast response, high control accuracy, good robust stability, but also has good universality.

### (2) Anti-Disturbance Performance Test

Anti-disturbance tests are performed on the controlled objects of two different models expressed by Equations (17) and (18) to verify the anti-disturbance capability of the invention, and the test results are described as follows.

### Anti-Disturbance Control Ability Test for Object 1

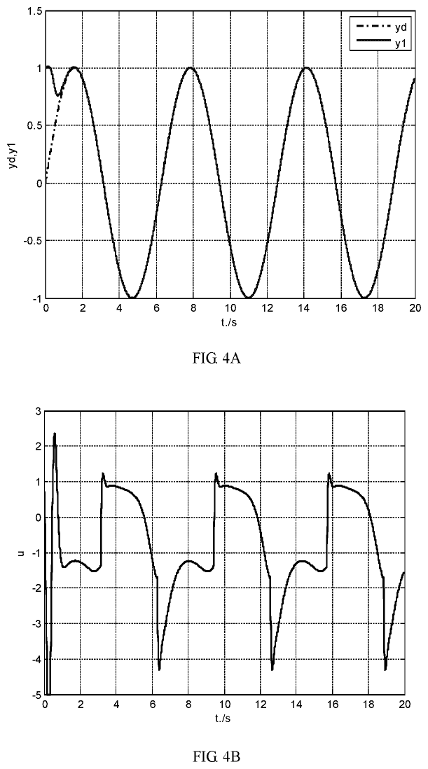

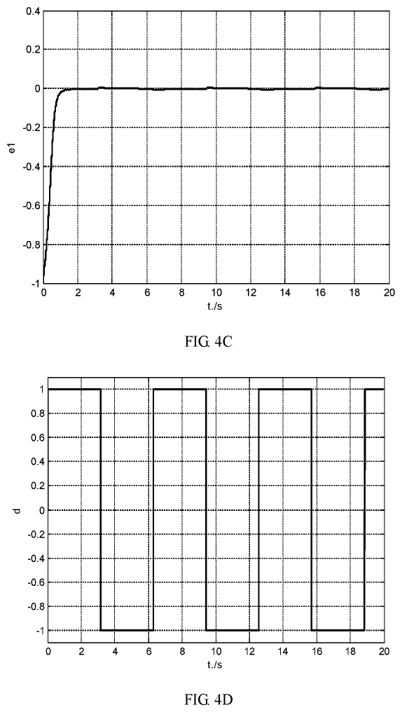

Given the desired trajectory as y_{d}=sin(t), in the case that there is an external disturbance with an amplitude of ±1 and the control method of the invention is used, the simulation results are as shown in FIGS. 4A-D. It can be seen that the DPC provided herein enables the controlled object to fully track the desired trajectory after about 0.7 s, which indicates that the invention not only has a fast response, high control accuracy, strong robust stability, but also has a strong anti-disturbance capability, demonstrating the superiority of the invention.

### Anti-Disturbance Control Ability Test for Object 2

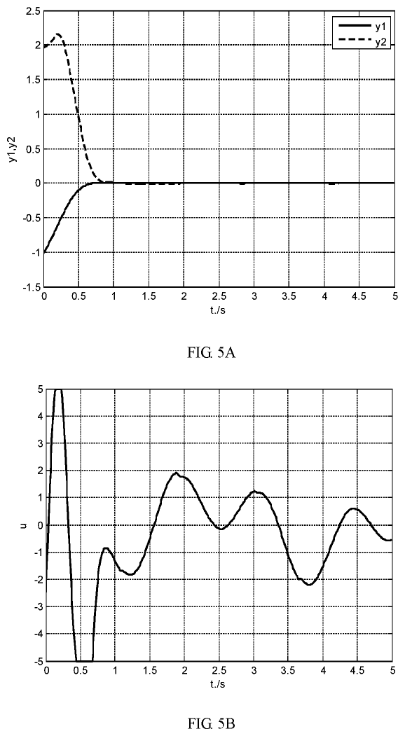

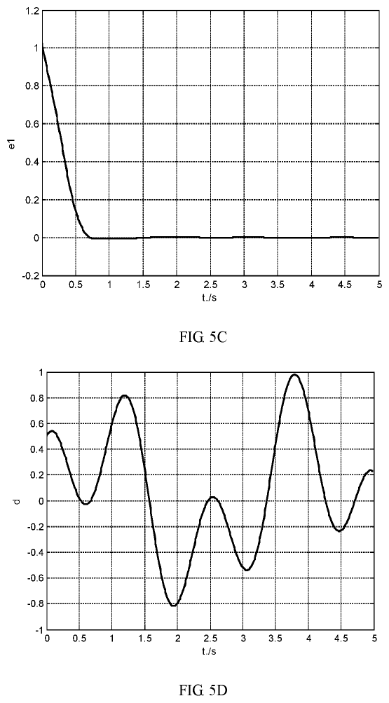

When the external disturbance is d=0.5 sin(2t)+0.5 cos(5t) and the control method of the invention is employed, the simulation results are as shown in FIGS. 5A-D. It can be seen that the inverted pendulum can approach the unstable equilibrium point i.e., (0, 0), from the initial state (−π/3,2) after about 0.7 s, which indicates that the invention not only has fast response and high control accuracy, but also has robust stability and good anti-disturbance capability. Therefore, the invention is actually a robust control method with global stability.

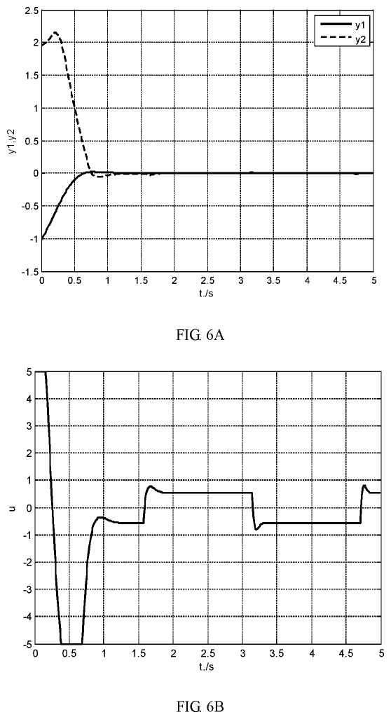

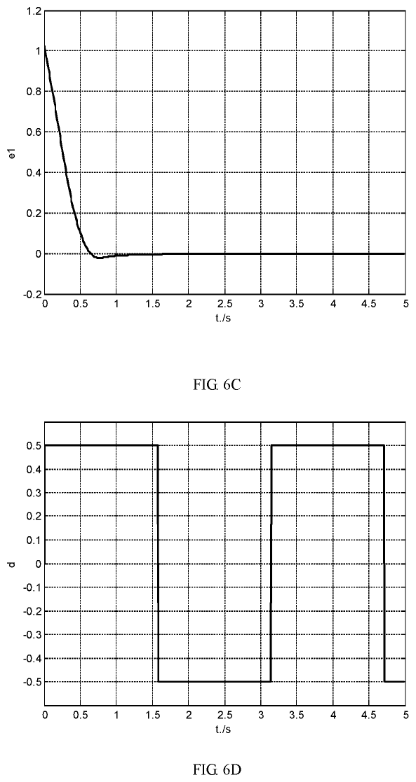

When the external disturbance is an oscillating signal with an amplitude of ±0.5, and the control method of the invention is employed, the simulation results are as shown in the FIGS. 6A-D. It can be seen that the inverted pendulum can approach the unstable equilibrium point, i.e., (0, 0), from the initial state (−π/3,2) after about 0.7 s, which indicates that the DPC controller of the invention not only has a fast response, high control accuracy and strong robust stability, but also has strong anti-disturbance capability, further demonstrating that the invention is a robust control method with global stability.

The above anti-disturbance test results show that a good anti-disturbance control effect is obtained when DPCs with the same gain parameter are employed to control two completely different objects (17) and (18), which indicates that the invention not only has fast response, high control accuracy and robust stability, but also has good anti-disturbance capability. Moreover, the DPC of the invention is further demonstrated to have good universality.

### 6. CONCLUSION

Although PID controller, Sliding Mode Control (SMC) and Active Disturbance Rejection Control (ADRC), based on cybernetic strategy (eliminating error based on error), are the three main controllers widely used in the field of control engineering, there are still some limitations in the traditional PID controllers. Specifically, the gain parameter is required to be adjusted with the change of working conditions, making it difficult to stabilize the parameter; the traditional PID controllers fail to apply non-linear control; and the traditional PID controllers do not have anti-disturbance capability. Given the above, various improved PID controllers, such as self-adaptive PID controller, nonlinear PID controller, parameter self-learning nonlinear PID controller, fuzzy PID controller, optimal PID controller, neuron PID controller, expert PID controller, have been developed, which largely overcome the problem of parameter stabilization in the traditional PID controllers and also have certain nonlinear control capabilities. However, the existing improved PID controllers are still lack of anti-disturbance capability, and have a large computational amount, which significantly affects the real-time control. Although SMC has good stability, there is an irreconcilable contradiction between the high-frequency buffeting and the anti-disturbance capability. Regarding ADRC, though it has a strong anti-disturbance capability, there are too many gain parameters, and the computational amount of related non-linear functions is too large, making it theoretically difficult to ensure the system stability. Compared to the three existing major controllers, the invention not only concentrates the respective advantages of the three major controllers, but also eliminates their respective limitations, that is, it not only has the advantages of simple structure, strong stability and strong anti-disturbance ability, but also effectively avoids the difficulty in parameter stabilization; solves the problem of irreconcilability between high-frequency buffeting and anti-disturbance ability; and avoids the excessive gain parameters and computational amount. The invention facilitates the development of the control theory system, and improves the stabilization of the gain parameter of a controller.

The invention can be widely applied in the fields of electric power, machinery, chemical industry, light industry and national defense industry.

What is claimed is:

1. A control method based on disturbance perception, comprising:
(1) establishing a tracking error e₁ and an integral e₀ thereof, and a differential e₂ based on a desired trajectory y_{d} and differential signals thereof [symbol] and [symbol] , and an actual output of a nonlinear uncertain object y equal to y=y₁:
$${e}_{1} = {y}_{d} - y , {e}_{2} = \text{?} - {y}_{2} , {e}_{0} = {\int }_{0}^{t} {e}_{1} d τ ;$$
$$\text{?} \text{indicates text missing or illegible when filed}$$
wherein, y₂= [symbol] = [symbol] ,
(2) defining a disturbance perception control law based on e₁, e₂, e₀ and [symbol] obtained from step (1): u=b₀⁻¹( [symbol] +z_{c}³e₀+3z_{c}²e₁+3z_{c}e₂);
wherein, z_{c}=h^{-α(}1.1−e^{-βt}); 0<α<1; 0<β≤0.5; h is integration step, b₀ is an estimate of a nonlinear uncertain function g(y₁, y₂, t), and is a non-zero constant; and
(3) limiting the integral e₀ of the tracking error to |e₀|≤z_{c}⁻³.
